(19) United States
(12) Patent Application Publication
(10) Pub. No.: US 2007/0143004 A1
(43) Pub. Date: Jun. 21, 2007

(54) Road configuration recognizing system for vehicle

(75) Inventor: Yasushi Sakuma, Kariya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/636,789

(22) Filed: Dec. 11, 2006

(30) Foreign Application Priority Data
Dec. 15, 2005 (JP) 2005-362213

(51) Int. Cl. G01C 21/00

(52) U.S. Cl. 701/200; 73/146

(57) ABSTRACT

A radar device transmits an outbound radar wave and receives a reflected radar wave, which is reflected from a reflective object, such as an guardrail, upon impingement of the outbound radar wave on the reflective object. A computer extracts an aggregation of adjacent points from a plurality of points, each of which indicates a distance and a direction of a corresponding part of the reflective object determined by the radar device. The computer recognizes a configuration of a road, on which an own vehicle is present, based on the aggregation of adjacent points when a length of the aggregation of adjacent points is equal to or greater than a predetermined value.

### CROSS REFERENCE TO RELATED APPLICATION

This application is based on and incorporates herein by reference Japanese Patent Application No. 2005-362213 filed on Dec. 15, 2005.

### BACKGROUND OF THE INVENTION

1. Field of the Invention

The present invention relates to a road configuration recognizing system for a vehicle.

2. Description of Related Art

Japanese Unexamined Patent Publication No. 2001-256600 (corresponding to U.S. Pat. No. 6,553,283 B2) recites a road configuration recognizing method for a vehicle. According to this method, a road configuration is recognized by connecting positions of highly reflective objects (e.g., cats-eyes arranged at predetermined intervals on a road) based on a distance from the vehicle to each corresponding reflective object.

The above-described road configuration recognizing method uses a laser radar, which has a high directional accuracy and senses the highly reflective objects for reflecting the light. However, when a wave radar, which has a lower directional accuracy in comparison to the laser radar and senses highly reflective objects for reflecting a wave, is used in the above case, the road configuration cannot be accurately recognized based on the positional information of the reflective objects.

### SUMMARY OF THE INVENTION

The present invention is made in view of the above disadvantages. Therefore, it is an objective of the present invention to provide a road configuration recognizing system, which can relatively accurately recognize a road configuration through use of a radar wave.

To achieve the objective of the present invention, there is provided a road configuration recognizing system for a vehicle. The road configuration recognizing system includes a wave radar means, a reflective object recognizing means, an aggregation extracting means, an aggregation length determining means and a road configuration recognizing means. The wave radar means is for transmitting an outbound radar wave and receiving a reflected radar wave, which is reflected from a reflective object upon impingement of the outbound radar wave on the reflective object. The reflective object recognizing means is for recognizing a distance of the reflective object from the vehicle and a direction of the reflective object relative to the vehicle based on the reflected radar wave, which is received by the wave radar means. The aggregation extracting means is for extracting an aggregation of adjacent points from a plurality of points. Each of the plurality of points indicates a distance and a direction of a corresponding part of the reflective object, which are relative to the vehicle and are recognized by the reflective object recognizing means on a polar coordinate system. The polar coordinate system indicates the direction of the reflective object relative to the vehicle along a first axis of the polar coordinate system and the distance of the reflective object from the vehicle along a second axis of the polar coordinate system. The aggregation length determining means is for determining whether a length of the aggregation of adjacent points is equal to or greater than a predetermined value. The road configuration recognizing means is for recognizing a configuration of a road, on which the vehicle is present, based on the aggregation of adjacent points when the aggregation length determining means determines that the length of the aggregation of adjacent points is equal to or greater than the predetermined value.

The aggregation length determining means may measure the length of the aggregation of adjacent points in a direction of the second axis that indicates the distance of the reflective object.

### BRIEF DESCRIPTION OF THE DRAWINGS

The invention, together with additional objectives, features and advantages thereof, will be best understood from the following description, the appended claims and the accompanying drawings in which:

FIG. 1 is a block diagram showing an entire structure of a vehicle-to-vehicle distance control system according to an embodiment of the present invention;

FIG. 2 is a block diagram showing a structure of a radar device according to the embodiment;

FIG. 3A is a diagram showing a relationship between a transmitted radar wave and a received radar wave for illustrating a principle of the embodiment;

FIG. 3B is a diagram showing an example of a mixed signal, in which the transmitted radar wave and the received radar wave are mixed;

FIG. 4 is a descriptive diagram for describing a measuring principle of a direction of a reflective object relative to an own vehicle in the radar device according to the embodiment;

FIG. 5 is a descriptive view for describing recognition of a road configuration through use of a reflected radar wave from roadside objects, such as guardrails;

FIG. 6 is a descriptive diagram for describing classification of non-moving object data;

FIG. 7 is a descriptive diagram for describing a way of determining whether the roadside object is on a left side or a right side of the own vehicle based on an X-axis intercept of an approximate curve; and

FIG. 8 is a flowchart showing a flow of a road configuration recognizing process according to the embodiment.

### DETAILED DESCRIPTION OF THE INVENTION

A road configuration recognizing system according to an embodiment of the present invention will be described with reference to the accompanying drawings. In the present embodiment, the road configuration recognizing system is implemented as a system, which constitutes a part of a vehicle-to-vehicle distance control system that controls a vehicle speed to maintain a predetermined vehicle-to-vehicle distance between own vehicle and a preceding vehicle at the time of executing a constant speed control operation.

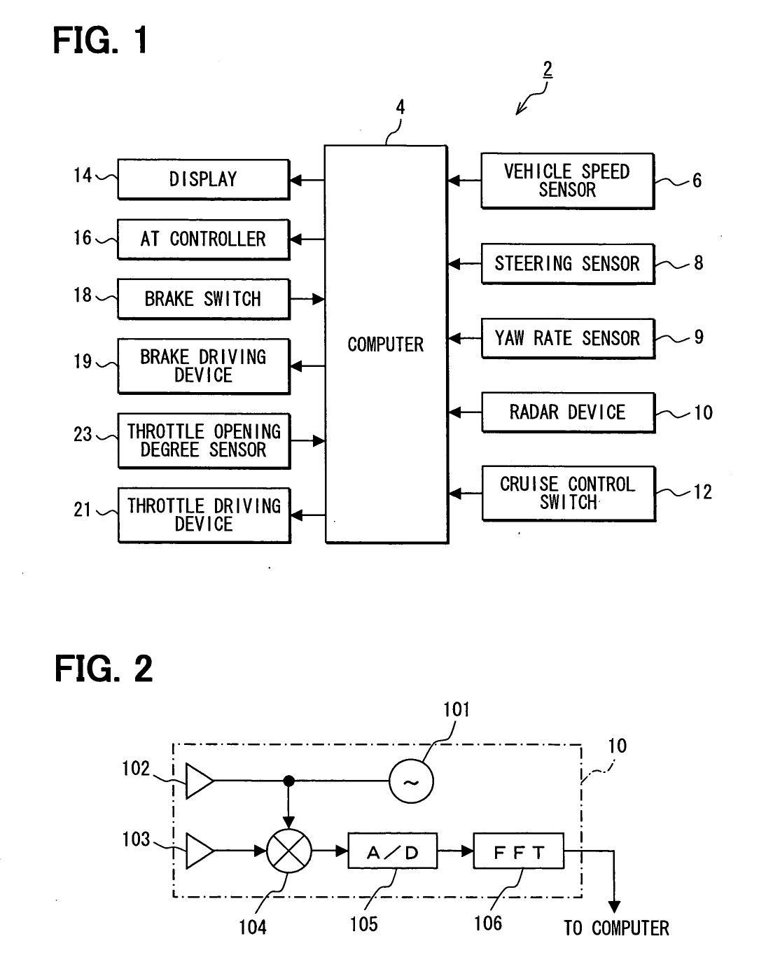

FIG. 1 shows an entire structure of the vehicle-to-vehicle distance control system 2. The vehicle-to-vehicle distance control system includes a computer 4 (a main component of the vehicle-to-vehicle distance control system), a vehicle speed sensor 6, a steering sensor 8, a yaw rate sensor 9, a radar device 10, a cruise control switch 12, a display device 14, an automatic transmission (AT) controller 16, a brake switch 18, a brake driving device 19, a throttle driving device 21 and a throttle opening degree sensor 23.

The computer 4 (also referred to as an electronic control unit) includes an input/output (I/O) interface and various drive circuits. The hard structure of these components are generally know and will not be discussed below. The computer 4 performs a vehicle-to-vehicle distance control operation to control a vehicle-to-vehicle distance between own vehicle and a preceding vehicle and also performs a constant speed travel control operation to maintain the vehicle speed at a preset speed in a case where no preceding vehicle is selected to execute the vehicle-to-vehicle distance control operation.

The vehicle speed sensor 6 is a sensor, which senses a signal that corresponds to a rotational speed of a vehicle wheel and which outputs the sensed signal to the computer 4. The steering sensor 8 senses an amount of change in a steering angle of a steering wheel and senses a relative steering angle of the steering wheel based on the sensed amount of change in the steering angle. The steering angle, which is sensed by the steering sensor 8, is outputted to the computer 4. The yaw rate sensor 9 senses an angular speed of the own vehicle about its vertical axis and outputs the sensed angular speed to the computer 4.

The cruise control switch 12 includes five push button switches, i.e., a main switch (SW), a set switch (SW), a resume switch (SW), a cancel switch (SW) and a tap switch (SW).

The main SW is a switch for enabling start of the cruise control operation (the constant speed travel control operation). In the constant speed travel control operation, the vehicle-to-vehicle distance control operation is also executed. When the set SW is pressed, the current vehicle speed of the own vehicle is read and is stored as a target speed. The constant speed travel control operation is performed after the target speed is set.

In the state where the target vehicle speed is stored during a period other than the period of the constant speed travel control operation, when the resume SW is pressed, the current vehicle speed of the own vehicle is changed to the target vehicle speed. The cancel SW is provided to cancel the constant speed travel control operation. Specifically, when the cancel SW is pressed, a cancel process for canceling the constant speed travel control operation is executed. The tap SW is provided to set a desired target vehicle-to-vehicle distance between the own vehicle and the preceding vehicle according to a user's preference.

The display device 14 includes a preset vehicle speed display, a vehicle-to-vehicle distance display and a sensor abnormality display. The preset vehicle speed display indicates the preset vehicle speed used in the constant speed travel control operation. The vehicle-to-vehicle distance display indicates the vehicle-to-vehicle distance between the own vehicle and the preceding vehicle based on the measurement result of the radar device 10. The sensor abnormality display indicates occurrence of a sensor abnormality when an abnormality exists in sensors, such as the vehicle speed sensor 6.

The automatic transmission controller 16 selects a shift position of an automatic transmission, which is required to control the vehicle speed of the own vehicle upon receiving a corresponding instruction from the computer 4. The brake switch 18 senses depression of a brake pedal, which is depressed by a driver. The brake driving device 19 adjusts a brake pressure based on a corresponding instruction received from the computer 4.

The throttle driving device 21 adjusts an opening degree of a throttle valve based on a corresponding instruction received from the computer 4 to control the output of the internal combustion engine. The throttle opening degree sensor 23 senses the opening degree of the throttle valve.

The computer includes an undepicted power supply switch (SW). When the power supply SW is turned on, the electric power is supplied to start predetermined processes. The computer 4 is constructed in the above described manner to perform the vehicle-to-vehicle distance control operation and the constant speed travel control operation.

The radar device 10 is a known radar device, such as a known frequency modulation continuous wave (FMCW) radar device. The radar device 10 is placed around a front grille of the vehicle and transmits an outbound radar wave in a micrometer wavelength or in a millimeter wavelength on the front side of the vehicle and receives reflected radar wave, which is reflected from a reflective object upon impingement of the outbound radar wave on the reflective object. Furthermore, a distance from the own vehicle to the reflective object, a relative speed of the reflective object relative to the own vehicle and a direction of the reflective object relative to the own vehicle are sensed based on the reflected radar wave. Next, a structure of the radar device 10 will be described.

FIG. 2 is a block diagram showing the structure of the radar device 10. As shown in FIG. 2, the radar device 10 includes an oscillator 101, a transmitting antenna 102, a receiving antenna 103, a mixer 104, an A/D converter 105 and an FFT 106.

The oscillator 101 is, for example, a voltage-controlled oscillator, which has an oscillation frequency that is controlled by a voltage input, so that the oscillation frequency of the oscillator 101 is modulated in a predetermined frequency range around a predetermined frequency.

The transmitting antenna 102 transmits the outbound radar wave on the front side of the vehicle. The receiving antenna 103 receives the reflected radar wave, which is reflected from the reflective object upon impingement of the outbound radar wave on the reflective object. The mixer 104 mixes an outbound radar signal generated by the oscillator 101 and a received radar signal received by the receiving antenna 103 to form a mixed signal.

The A/D converter 105 converts an analog signal (hereinafter, referred to as “beat signal”) to a digital signal. FFT 106 converts the beat signal in the time domain into data of power spectrum in a frequency range. Based on the power spectrum data, the distance from the own vehicle to the reflective object, the relative speed of the reflective object relative to the own vehicle and the direction of the reflective object relative to the own vehicle are obtained. The distance from the own vehicle to the reflective object, the relative speed of the reflective object relative to the own vehicle and the direction of the reflective object relative to the own vehicle are outputted to the computer 4.

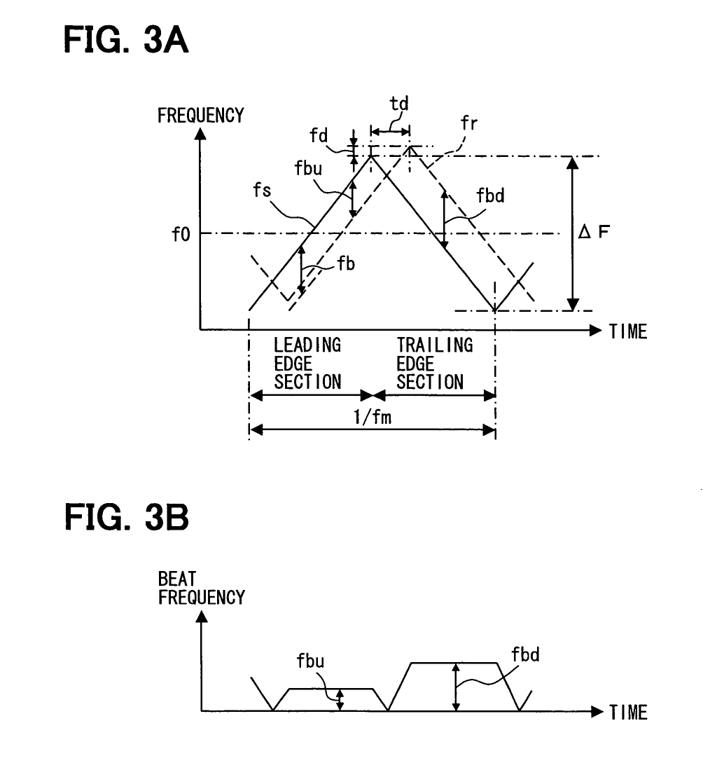

Next, a measuring principle of the radar device 10 will be described with reference to the accompanying drawings. FIG. 3A shows an exemplary case where an outbound radar wave fs is outputted from the transmitting antenna 102, and an inbound radar waver fr, which is a reflected radar wave that is reflected from a reflective object, is received by the receiving antenna 103. As shown in FIG. 3A, the outbound radar wave fs is transmitted repeatedly at every 1/fm from the transmitting antenna 102 while the outbound radar wave fs is frequency modulated within a range of a modulation amplitude ΔF, which has its center at a frequency f0.

The inbound radio wave fr is reflected from the reflective object upon impingement of the outbound radar wave fs on the reflective object and is received by the receiving antenna 103. The inbound radar wave fr shows a time lag td and a frequency shift relative to the transmitted radar wave fs. In the radar device 10 of the present embodiment, the distance of the reflective object from the own vehicle and the relative speed of the reflective object are obtained based on the time lag td and the frequency shift.

Specifically, in the case where the relative speed of the reflective object relative to the own vehicle is zero, the reflected radar wave shows the corresponding time lag td, which is proportional to the distance from the own vehicle to the reflective object. Furthermore, the frequency shift is generated due to the Doppler effect. Specifically, when the relative movement exits between the own vehicle and the reflective object, the amount of frequency shift of the outbound radar wave fs, which is transmitted from the own vehicle, changes in response to the relative speed of the reflective object. Therefore, the relative speed of the reflective object can be obtained based on this amount fd of frequency shift.

FIG. 3B shows the beat signal, which is produced by the mixer 104 that mixes the outbound radar wave fs and the inbound radar wave fr. With reference to FIG. 3B, a beat frequency fbu indicates the amount of frequency shift between the outbound radar wave fs and the inbound radar wave fr in a leading edge section, and a beat frequency fbd indicates the amount of frequency shift between the outbound radar wave fs and the inbound radar wave fr in a trailing edge section.

A frequency fb, which corresponds to the distance of the reflective object from the own vehicle, and a frequency fd, which corresponds to the relative speed of the reflective object, can be obtained based on the two beat frequencies fbu, fbd through the following equations. In the following equations 1, 2, “ABS” denotes an absolute value.
fb=[ABS(fbu)+ABS(fbd)]/2 (Equation 1)
fd=[ABS(fbu)−ABS(fbd)]/2 (Equation 2)

Furthermore, when these frequencies fb, fd are applied in the following equations 3, 4, the distance of the reflective object from the own vehicle and the relative speed of the reflective object are computed. In the following equations 3, 4, “C” denotes the light speed.
Distance=C/(4×ΔF×fm)×fb (Equation 3)
Relative Speed=(C/2×f 0)×fd (Equation 4)

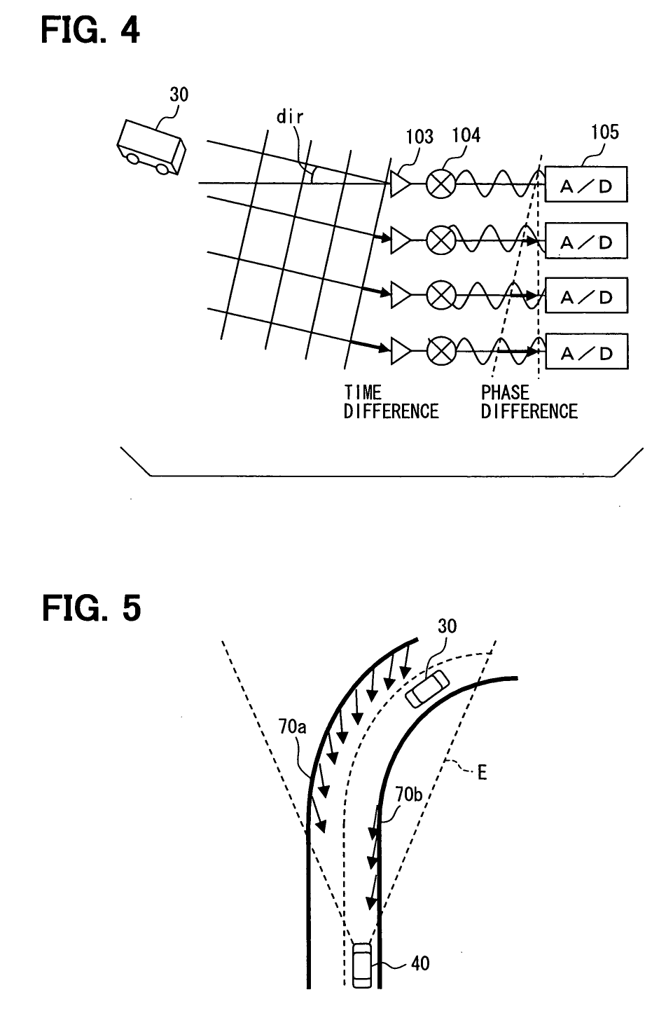

Next, a measuring principle for measuring the direction of the reflective object relative to the own vehicle will be described. As shown in FIG. 4, in the present embodiment, the outbound radar wave, which is transmitted from the transmitting antenna 102, is reflected by the reflective object, and this reflected radar wave is received by the receiving antenna 103. The direction of the reflective object relative to the own vehicle is determined based on the inbound radar wave, which is received by each receiving antenna 103.

Specifically, in the case where the multiple receiving antennas 103 are arranged one after another in the width direction (lateral direction) of the own vehicle, when the preceding vehicle 30 travels on the same straight lane as the own vehicle, a substantial difference does not exist in the arrival time of the reflected radar wave to the multiple receiving antennas 103. Therefore, the beat signals, which are supplied to the A/D converters 105, do not show a substantial phase difference since the reflected radar wave is received by the multiple receiving antennas 103 generally at the same time.

However, as shown in FIG. 4, when the vehicle is traveling along a curved road, the arrival time of the reflected radar wave varies among the receiving antennas 103, so that time differences exist in the arrival times of the radar wave to the antennas 103. These time differences will appear as phase differences in the beat signals, which are supplied to the A/D converter 105. Thus, the direction of the reflective object (e.g., the preceding vehicle 30) relative to the own vehicle can be determined based on the phase differences.

The computer 4 shown in FIG. 1 performs the road configuration recognizing process for recognizing the configuration of the road, on which the own vehicle is present, based on the distance and the direction of the reflective object that is identified as a non-moving object because of its zero relative speed measured by the radar device 10. Then, the computer 4 computes a turning radius (a radius of curvature) R of the road, on which the own vehicle exits, based on the recognized road configuration, which is recognized through the road configuration recognizing process.

Furthermore, based on the distance and the direction of a moving reflective object (e.g., a preceding vehicle), which is other than the non-moving object, the computer 4 computes a coordinate (X, Y) of a center position (hereinafter, referred to as a center position coordinate) of the moving reflective object on a planar coordinate system (an X, Y coordinate system), in which the X-axis corresponds to a width direction of the vehicle, and the Y-axis corresponds to a fore-and-aft direction of the vehicle. In this process, when the converted resultant value is in an abnormal range, the abnormality is indicated on the sensor abnormality display of the display device 14.

Furthermore, the computer 4 computes a rotational angle of the preceding vehicle about the vertical axis thereof with respect to the own vehicle on the curved road based on the turning radius R of the own vehicle and the center position coordinate (X, Y) of the preceding vehicle. Then, the computer 4 computes a lateral position correction amount based on this rotational angle. When the own vehicle is traveling along the straight road, the turning radius R will be an extremely large value, resulting in a computation trouble. To encounter with this trouble, a predetermined countermeasure will be taken in the case where the turning radius R is equal to or greater than a predetermined value.

Furthermore, the computer 4 uses the rotational angle (theta) of the preceding vehicle about the vertical axis thereof and the distance L of the preceding vehicle from the own vehicle on the Y-coordinate of the center position of the preceding vehicle to compute the lateral position correction amount, and the computer 4 uses this lateral position correction amount to correct the center position of the preceding vehicle. Then, it is determined whether the vehicle-to-vehicle distance control operation needs to be performed with respect to the preceding vehicle based on the corrected center position of the preceding vehicle. When it is determined that the vehicle-to-vehicle distance control operation needs to be performed with respect to the preceding vehicle, corresponding control signals for adjusting the vehicle-to-vehicle distance with respect to the preceding vehicle are outputted from the computer 4 to the brake driving device 19, the throttle driving device 21 and/or the automatic transmission controller 16 based on the distance between the own vehicle to the preceding vehicle, the relative speed of the preceding vehicle relative to the own vehicle, the speed of the own vehicle, a setting state of the cruise control switch 12 and an operational state of the brake switch 18. The computer 4 also outputs a required display signal to the display device 14 to notify the current situation to the driver of the vehicle.

Thus, the throttle driving device 21 may be driven to control the throttle opening degree, and/or the automatic transmission controller 16 may be operated to control the gear position of the automatic transmission. Furthermore, the brake driving device 19 may be operated to control the brake pressure. In this way, the vehicle-to-vehicle distance between the own vehicle and the preceding vehicle is maintained at the target vehicle-to-vehicle distance. Furthermore, the real time state is displayed on the display device 14.

Now, the road configuration recognizing process of the present embodiment will be described. With reference to FIG. 5, a range of an outbound radar wave, which is transmitted from the radar device 10, is indicated by numeral E, and the radar wave, which is transmitted from the radar device 10 of the own vehicle 40, impinges not only on the preceding vehicle 30 but also on roadside objects (e.g., guardrails) 70a, 70b. The recognized distance and direction of each of the roadside objects 70a, 70b, which are recognized based on the reflected radar waves reflected from the roadside objects 70a, 70b, are indicated by corresponding arrow headed lines in FIG. 5. In the road configuration recognizing process of the present embodiment, the road configuration is recognized based on the reflected radar wave, which is reflected from the roadside objects.

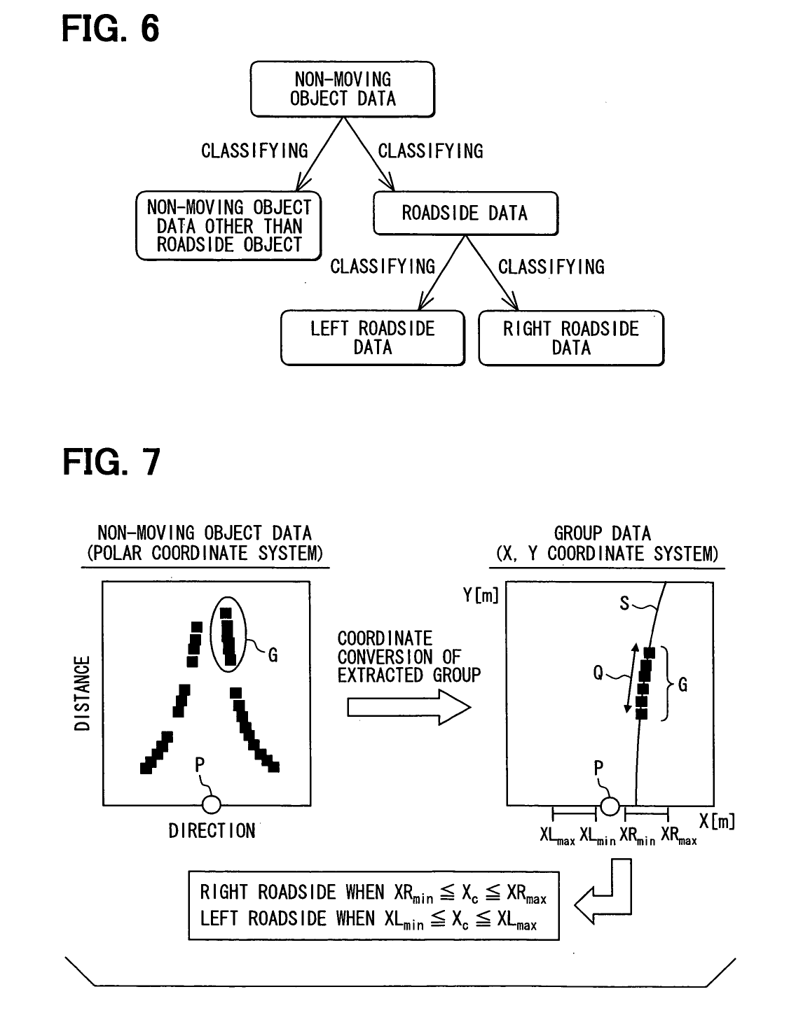

With reference to FIG. 6, the road configuration recognizing process uses the distance and the direction (non-moving object data) of each corresponding reflective object, which is identified as having zero relative speed, i.e., is identified as the non-moving object in view of the outputs (the distance of the reflective object from the own vehicle, the relative speed of the reflective object and the direction of the reflective object relative to the own vehicle) of the radar device 10. The non-moving object data includes the roadside objects (e.g., the guardrails) and the other non-moving objects other than the roadside objects. Thus, as shown in FIG. 6, the non-moving object data is classified into non-moving object data of the roadside objects (roadside data) and the non-moving object data of objects other than the roadside objects. Furthermore, as shown in FIG. 6, the roadside data (the data of the road side objects, such as the guardrails) is classified into right roadside data (i.e., data of the non-moving objects in the right side of the road) and left roadside data (i.e., data of the non-moving objects in the left side of the road).

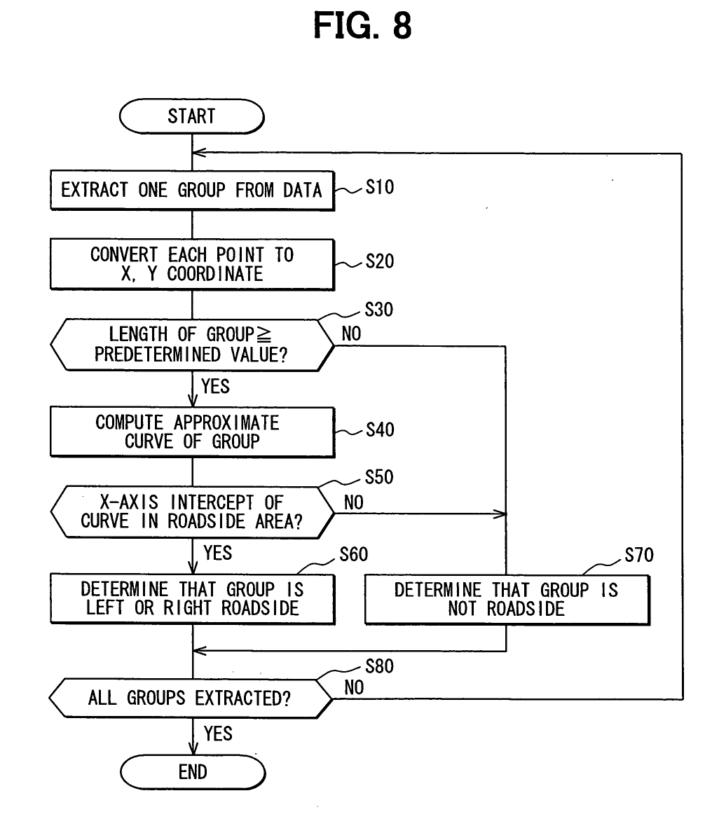

Next, the road configuration recognizing process executed by the computer 4 will be described with reference to a flowchart shown in FIG. 8. At step S10, as shown in FIG. 7, an aggregation (group) G of corresponding adjacent points, which are within a predetermined direction range and also within a predetermined distance range, is extracted from points of non-moving object(s), each of which is indicated on a polar coordinate system in view of the distance of the non-moving object from the own vehicle and the direction of the non-moving object from the own vehicle. This is due to the fact that the non-moving objects, such as the guardrails, which are placed along the road, appear as the points, which are within the predetermined direction range and also within the predetermined distance range.

At step S20, each point of the extracted group G is converted into a corresponding point in the planar coordinate system (X, Y coordinate system), in which the center of the radar device 10 is used as an origin (0, 0) of the planar coordinate system, and the width direction and the fore-and-aft direction of the vehicle (a position of the vehicle is indicated by P in the drawing) correspond to the X-axis (axis of abscissas) and the Y-axis (axis of ordinate), respectively, of the planar coordinate system. At step S30, it is determined whether a length Q of the group G generally in the direction of the Y-axis in the X, Y coordinate system is equal to or greater than a predetermined value. Here, when YES is returned at step S30, control proceeds to step S40. In contrast, when NO is returned at step S30, control proceeds to step S70.

At step S40, an approximate curve S of the group G, which has the length Q of equal to or greater than the predetermined value, is computed. At step S50, it is determined whether an X-axis intercept (an intercept on the X-axis) of the thus computed approximate curve S in the X, Y coordinate system obtained at step S40 is in a corresponding roadside area (predetermined right side coordinate value range or predetermined left side coordinate value range). Specifically, it is determined whether one of the following equation 5 and equation 6 is satisfied. In the following equations, “Xc” denotes the X-axis intercept of the approximate curve S.
XRmin≦Xc≦XRmax (Equation 5)
XLmin≦Xc≦XLmax (Equation 6)

Here, when one of the equation 5 and the equation 6 is satisfied, control proceeds to step S60. In contrast, when none of the equation 5 and the equation 6 is satisfied, control proceeds to step S70. At step S60, when the equation 5 is satisfied, the group G is determined as the roadside object on the right side of the road. In contrast, when the equation 6 is satisfied, the group G is determined as the roadside object on the left side of the road.

That is, the roadside object, such as the guardrail, is placed along the road. Thus, when the points of the non-moving object data, which correspond to this roadside object, are connected together, these points form the curve in the coordinate system. Therefore, it is possible to compute the approximate curve S, which indicates the configuration of the roadside object, based on the aggregation of adjacent points. Thereby, it is possible to determine whether the roadside object is on the left side or right side of the own vehicle based on the position of the X-axis intercept of the approximate curve S on the X, Y coordinate.

Furthermore, the lateral position of the roadside object, such as the guardrail, relative to the center position of the own vehicle in the lateral direction of the own vehicle is assumed to be in a certain distance range. Therefore, it is possible to determine whether the roadside object is on the left side or right side of the own vehicle based on whether the X-axis intercept of the approximate curve S satisfies the equation 5 or the equation 6.

At step S70, it is determined that the group G is not the roadside object. As described above, when the equation 5 or the equation 6 is satisfied, the subject group G can be determined as the roadside object. In contrast, when none of the equation 5 and the equation 6 is satisfied, or when the length of the subject group G is not equal to or greater than the predetermined value, the subject group G can be determined as the reflective object other than the roadside object. At step S80, it is determined whether all groups are extracted. When YES is returned at step S80, the present process is terminated. In contrast, when NO is returned at step S80, control returns to step S10 to repeat the above steps for the remaining group(s).

As described above, the road configuration recognizing process, which is executed in the vehicle-to-vehicle distance control system, extracts the group G of adjacent points from the points, each of which indicates the distance and the direction of the corresponding reflective object on the coordinate system. When the length Q of the extracted group G is equal to or greater than the predetermined length, the road configuration recognizing process recognizes the configuration of the road, on which the own vehicle is located, based on the extracted group G. In this way, the road configuration can be relatively accurately recognized through use of the wave radar without use of the laser radar.

Additional advantages and modifications will readily occur to those skilled in the art. The invention in its broader terms is therefore not limited to the specific details, representative apparatus, and illustrative examples shown and described.

What is claimed is:

1. A road configuration recognizing system for a vehicle, comprising:
a wave radar means for transmitting an outbound radar wave and receiving a reflected radar wave, which is reflected from a reflective object upon impingement of the outbound radar wave on the reflective object;
a reflective object recognizing means for recognizing a distance of the reflective object from the vehicle and a direction of the reflective object relative to the vehicle based on the reflected radar wave, which is received by the wave radar means;
an aggregation extracting means for extracting an aggregation of adjacent points from a plurality of points, wherein each of the plurality of points indicates a distance and a direction of a corresponding part of the reflective object, which are relative to the vehicle and are recognized by the reflective object recognizing means on a polar coordinate system, and the polar coordinate system indicates the direction of the reflective object relative to the vehicle along a first axis of the polar coordinate system and the distance of the reflective object from the vehicle along a second axis of the polar coordinate system;
an aggregation length determining means for determining whether a length of the aggregation of adjacent points is equal to or greater than a predetermined value; and
a road configuration recognizing means for recognizing a configuration of a road, on which the vehicle is present, based on the aggregation of adjacent points when the aggregation length determining means determines that the length of the aggregation of adjacent points is equal to or greater than the predetermined value.

2. The road configuration recognizing system according to claim 1, wherein the aggregation length determining means measures the length of the aggregation of adjacent points in a direction of the second axis that indicates the distance of the reflective object.

3. The road configuration recognizing system according to claim 1, wherein the road configuration recognizing means includes:
an approximate curve computing means for computing an approximate curve from the aggregation of adjacent points when the aggregation length determining means determines that the length of the aggregation of adjacent points is equal to or greater than the predetermined value; and
an aggregation location determining means for determining whether the aggregation of adjacent points is on a right side or a left side of the vehicle based on a position of an intercept of the approximate curve on the first axis.

4. The road configuration recognizing system according to claim 3, wherein:
the approximate curve computing means includes a coordinate converting means for converting the polar coordinate system into a planar coordinate system;
a position of the vehicle is at an origin of the planar coordinate system, and a fore-and-aft direction and a lateral direction of the vehicle correspond to an axis of ordinate and an axis of abscissas, respectively, of the planar coordinate system;
the approximate curve computing means computes the approximate curve on the planar coordinate system, which is converted from the polar coordinate system by the coordinate converting means; and
the aggregation location determining means determines whether the aggregation of adjacent points is on the right side or the left side of the vehicle by determining whether the intercept of the approximate curve on the axis of abscissas is within a predetermined right side coordinate value range or a predetermined left side coordinate value range, which are associated with the right side or the left side, respectively, of the vehicle.

5. The road configuration recognizing system according to claim 4, wherein when the aggregation location determining means determines that the interception of the approximate curve is within the predetermined right side coordinate value range or the predetermined left side coordinate value range, the aggregation location determining means determines that the aggregation of adjacent points is a roadside object.

6. The road configuration recognizing system according to claim 1, wherein the aggregation extracting means extracts the aggregation of adjacent points, which are within a predetermined direction range and also within a predetermined distance range.
